(19) United States
(12) Patent Application Publication
(10) Pub. No.: US 2026/0368166 A1
(43) Pub. Date: Nov. 19, 2026

(54) System and Method for Real-Time, Local-First Artificial Intelligence Guidance During Live Conversations

(71) Applicant: XERPA AI Inc., Saratoga Springs, UT (US)

(72) Inventors: Skyler Taylor, Saratoga Springs, UT (US); Logan Taylor, Eagle Mountain, UT (US); Samuel Tanner, Yukon, OK (US)

(73) Assignee: XERPA AI Inc., Saratoga Springs, UT (US)

(21) Appl. No.: 19/360,928

(22) Filed: Oct. 16, 2025

Related U.S. Application Data
(60) Provisional application No. 63/806,957, filed on May 16, 2025.

(51) Int. Cl. G06F 16/2453; G06F 16/248; G06F 40/295; G06F 40/30; G06F 40/40

(52) U.S. Cl. CPC G06F 16/24539; G06F 16/248; G06F 40/295; G06F 40/30; G06F 40/40

(57) ABSTRACT

Disclosed are computer systems and methods for providing AI assistance based on audio input in real time. The assistance may comprise suggested responses to a guided participant during a conversation in response to other conversation participant(s). Generating the suggested response may include receiving audio input through a network connection, transcribing the audio input into a text transcript, identifying an intent within the text transcript, querying a vector database to retrieve relevant database content based on the intent, prompting a LLM to generate a response based on the intent and the relevant database content, and presenting the response in real time. Generating the response may also include querying a semantic cache to search for semantically-similar text. When semantically-similar text is found, the cached response associated with the semantically-similar text may be presented. Otherwise, the LLM may be instructed to generate a new response.

### BACKGROUND

Artificial intelligence (AI) has seen increased use as a digital assistant, emerging in areas including communication (email, SMS, voice-to-text, etc.), banking, customer service, and technical support, among others. AI assistance contains the potential of quick and automated generation, increasing efficiency, shortening timelines, and lowering costs. Despite this, many challenges to effective AI assistance remain, including hallucinatory errors, inherit bias, and privacy concerns.

### SUMMARY

Disclosed are computer systems and methods for providing artificial intelligence (AI) search and assistance in real-time based on audio input. The computer system may include a display comprising a user interface for presenting instructions, a network connection, one or more processors communicatively coupled with the display, and the network connection, and one or more computer-readable media. The one or more computer-readable media may store a local semantic cache comprising a repository of information including a plurality of cached responses to specific questions. The one or more computer-readable media may store instructions that, when executed by the one or more processors, implement a method for providing AI search and assistance in real time based on the audio input.

The method may comprise receiving the audio input through system audio of the computer system, transcribing the audio input into a text transcript, and determining via a natural language processing model whether an intent comprising an objection, question, request, or pain point is present within the text transcript. When an intent is detected within the text transcript the method may further comprise define a first subset of the text transcript that includes the intent and querying the local semantic cache based on the first subset of the text transcript to search for a semantically-similar text as the first subset of the text transcript. When semantically-similar text is found, present a cached response associated with the semantically-similar text may be presented via the display in real time.

When semantically-similar text is not found, the method may also include querying a vector database based on a second subset of the text transcript to retrieve relevant database content, wherein the vector database comprises subject-specific information and wherein the relevant database content comprises subject-specific information within the vector database that is closely connected to a subject of the text transcript. The method may then comprise generating a prompt including the second subset of the text transcript, the intent, and the relevant database content, providing the prompt to a large language model (LLM) to generate a new response based on the text transcript, the intent, and the relevant database content, and present the new response via the display in real time. The prompt may further comprise text transcript from recent audio input and/or external customer relations management (CRM) conversation data, such that the new response is further based on the recent audio input and/or the external CRM conversation data.

The search for a semantically-similar text as the first subset of the text transcript may be performed by a probabilistic model, wherein each of the specific questions of the local semantic cache may be assigned a similarity score, and wherein the cached response may be presented only when at least one of the specific questions of the local semantic cache has a similarity score above a confidence threshold. Querying the vector database may further comprise vectorizing the second subset of the text transcript to facilitate comparison of the second subset of text transcript and information within the vector database.

The instructions may further cause the one or more processors to present the cached response or new response in a graphical overlay of the display that is excluded from video capture streams of screen-sharing applications. The method may include, when semantically-similar text is not found within the local semantic cache and after the new response is generated, storing the second subset of the text transcript within the local semantic cache and associate the new response with the second subset of the text transcript.

In some embodiments, the first subset is smaller portion of the text transcript than the second subset. The instructions may further cause the one or more processors to analyze a vocal tonality of the audio input. The method may include analyzing a video stream associated with the audio input to detect an emotional state, wherein generation of the prompt provided to the LLM may be further based on the emotional state, such that the new response is based on the emotional state.

The instructions may further comprise asynchronously analyzing the text transcript against a predefined conversational framework by a methodology adherence agent, wherein the cached response or the new response is accompanied by a coaching prompt generated by the LLM conforming to the predefined conversational framework, and wherein the coaching prompt is generated when a deviation from the predefined conversational framework is detected. The instructions may comprise identifying an action item within the text transcript based on a named entity recognition (NER) model and transmit data corresponding to the action item to an external customer relationship management (CRM) system.

The vector database may be stored on a cloud device and the LLM may comprise a local LLM that may be stored on a local device. The instructions may include, when semantically-similar text is found, outputting to the display an indication that the cached response is associated with the semantically-similar text. The method may include presenting a new response in addition to the cached response based on a local input to the computer system. The instructions stored on the one or more computer-readable media may be executed on a single electronic device.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 illustrates a diagram of additional system architecture, showing primary software and hardware components that may be used to implement the disclosure.

FIG. 2 illustrates a method for providing real-time response based on the reception of audio input.

FIG. 3 illustrates a user interface that may be used by the computer system to provide information to a guided participant.

FIG. 4 illustrates a diagram of the bifurcated architecture of the multi-agent system, specifically showing the parallel real-time “hot path” and asynchronous “cold path” processing flows.

FIG. 5 shows an illustrative computational system for performing functionality to facilitate implementation of embodiments described in this document.

### DETAILED DESCRIPTION

The present disclosure pertains generally to the field of human-computer interaction and artificial intelligence (AI). Specifically, the disclosure relates to systems and methods for providing real-time, context-aware assistance to a guided participant based on audio input. In many professional domains, the ability of a conversation participant to access and articulate accurate information in real-time during a live conversation is critical for success. For example, during a sales call, a representative may be required to answer a wide range of detailed questions regarding product features, pricing, security protocols, and competitive differentiation. Because humans have cognitive limitations, the inability for a human to respond to detailed questions quickly, accurately, and confidently can result in a poor customer experience and lost opportunities.

The disclosed embodiments provide several benefits over conventional systems and methods of information retrieval. In comparison, manual search and retrieval is slow and requires a participant to disengage from a conversation to manually formulate a search query, navigate the user interface, and parse the results. This process can be slow, disruptive to the conversational flow, and appears unprofessional to other participants. Post-conversation analysis may offer retrospective insight for training and strategic review, but does not provide a participant with the real-time assistance needed to respond appropriately (e.g., to answer a question or handle an objection) to other conversation participants. Such methods may affect future call experience, but may not improve real-time experience.

The advent of large language models (LLMs) accessible via general-purpose chatbots, such as ChatGPT, provides another potential avenue for assistance. However, these systems are ill-suited for the professional conversational context. They are not integrated into a participant's workflow, necessitating a disruptive process of manually copying conversational text. Such systems are relatively slow and prevent a participant from real-time interaction. Furthermore, they operate on public data, not a participant's private and secure knowledge base, and are prone to generating inaccurate or “hallucinated” information. This lack of factual grounding on proprietary data makes them unreliable for business-critical interactions. In addition, the latency inherent in many LLM systems can be too great for use in real-time applications while the use of many LLM systems requires providing potentially sensitive information to untrusted sources.

In contrast, the disclosed embodiments enable a guided participant to receive instruction and assistance to respond to conversation participants with subject-specific information while maintaining a conversation with other participants without disruption. The computer system may implement several steps to provide timely assistance to the guided participant, including receiving the audio input, transcribing the audio input into a text transcript, and identifying an intent within the text transcript via a natural language processing model. Afterwards, the computer system may query the vector database to retrieve relevant database content based on the text transcript and/or the detected intent, prompt a LLM (such as a local LLM or a cloud-based LLM) to generate a response based on the text transcript, the detected intent and the relevant database content, and present the response via the display in real time.

In some embodiments, the computer system may query a local semantic cache to search for a semantically-similar text prior to querying the vector database. When a semantically-similar text is found, the computer system may present a cached response associated with the semantically-similar text. Otherwise, the computer system may continue as described above.

Such systems may provide real-time assistance without the time delay required for a person to search through the knowledge base, while maintaining information accuracy and person-to-person interaction. These steps may be referred to as a retrieval-augmented generation (RAG) pipeline or “hot path”. While one could, given enough time, search for and find relevant information within a knowledge base and suggest to a guided participant the needed information, a human operator would not have time to search the whole knowledge base and identify the relevant information near instantaneously while the issue remains relevant during the conversation. An AI model may enable presentation of a suggested response to the guided participant on a short time scale (e.g., on the order of milliseconds or less than one second), in real time, during the conversation between the guided participant and other conversation participants, and thus minimizes disruption to the flow of conversation.

The generated information of the response may be presented to the guided participant through a display. The computer system may render guidance in a non-intrusive screen overlay. Such guidance may be invisible to third-party screen-sharing applications. This may be achieved through operating system-level rendering techniques that create a visual layer not included in the video capture stream of common collaboration tools, allowing the guided participant to receive private instruction without distracting other conversation participants.

Also disclosed is a multi-agent evaluation and enablement system, or “cold path”. This system may operate on a bifurcated architecture, separating time-critical hot path tasks from more complex, asynchronous cold path analyses. While the real-time RAG pipeline may provide immediate or near-immediate support for direct questions, specialized AI agents may continue analyses in the background. These agents can perform tasks such as, for example, analyzing conversational data against established sales methodologies (e.g., MEDDICC, BANT), identifying and clustering recurring objections from past calls, detecting action items for automated logging and follow-up, and integrating with external enterprise systems, such as customer relationship management (CRM) platforms (e.g., HubSpot®) or knowledge management tools (e.g., Notion®), via application programming interfaces (APIs) and software development kits (SDKs).

Embodiments disclosed in this document may provide a fundamental paradigm shift away from the human replacement model. Instead of creating an autonomous agent, the present disclosure, for example, may provide a coach for a human user. The system may not output a synthesized voice response delivered to a conversation participant, but rather may output a discreet textual prompt provided exclusively to the guided participant, who retains full control over the conversation. This may redefine the technical problem from one of automating a human role to one of augmenting and elevating human capabilities. This human augmentation framework may inform various aspect of the invention's architecture, such as local-first execution and/or a non-intrusive user interface.

While the disclosure may be generally described in the context of sales, the system's architecture is broadly applicable to any domain requiring real-time conversational assistance, such as, for example, the areas of technical support, medical consultations, or legal depositions, as well as internal use cases like new employee onboarding, customer success, hiring, human resources, and presentation coaching.

As used herein, the term “conversation” may refer to an audio or video interaction between two or more participants. The conversation may be pertinent or relevant to a specific subject, with one or more participants having an intent that may be remedied with subject-specific information from a guided participant. The conversation may occur in real-time, such that conversation participants may respond to one another without significant delay. The conversation may occur over a network and the audio produced by the participants may be communicated and received through a webpage. The conversation may be referred to by other terms, such as a “call.”

As used herein, the term “conversation participant” (i.e., participant) may refer to a person or entity that provides audio input in real-time made available to the computer system during the conversation.

The term “guided participant” may refer to a conversation participant that receives guidance or assistance from the computer system to further the conversation. For example, the guided participant may be a sales representative, a trainer, a tutor, or other person receiving assistance from the computer system. The term “user” may refer to the guided participant, specifically to one who is interacting with the user interface (UI) of the computing system to receive assistance in responding during a conversation.

As used herein, the term “audio input” may refer to audio generated during a conversation (e.g., a live conversation) by a conversation participant. Audio input may be generated, for example, in a sales call, technical support interaction, training session, or medical consultation.

As used herein, the term “ingest” may refer to receiving data into a system for processing (e.g., organizing), storage, and/or editing (e.g., format conversion for efficient use).

As used herein, the term “response” or “suggested response” may refer to a message generated by the computer system to the guided participant for navigating the conversation. The response may provide subject-specific information pertinent to the subject of the conversation or may comprise other instructions to the guided participant for controlling a direction of the conversation.

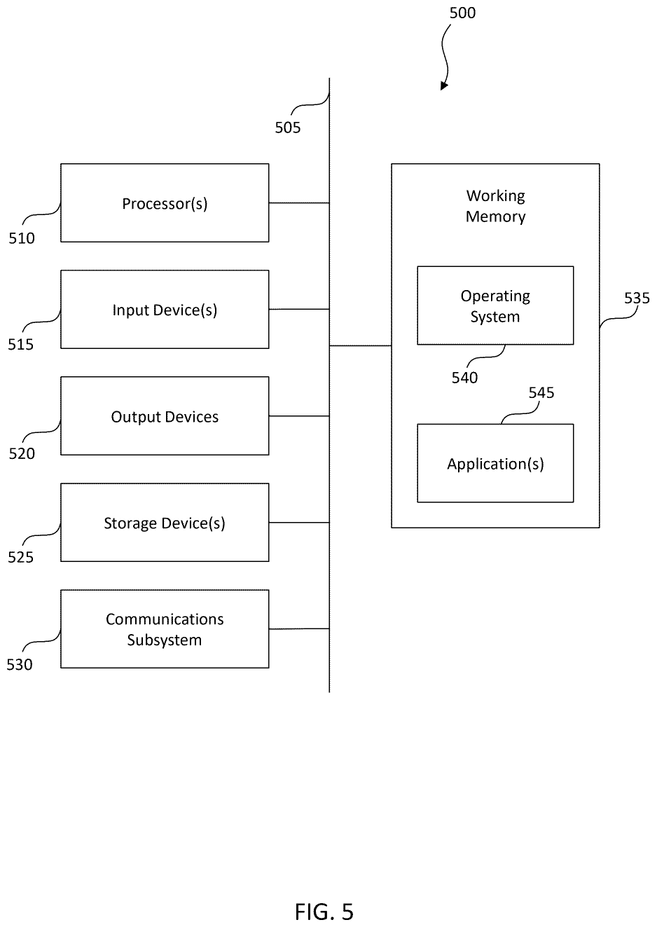

As used herein, the term “computing device” may refer to an electronic device that interfaces with a guided participant for communicating suggested responses from the computer system. A computing device may include all or some of the computational system 500 (see FIG. 5 below).

As used herein, the terms “real time” and “real-time” may refer to an event or set of events that are processed within milliseconds, such as within approximately 100, 200, 300, 400, 500, 600, 700, 800, 900, or 1000 milliseconds, so that results of the event or set of events are available virtually immediately as feedback. The terms “real time” and “real-time” may additionally, or alternatively, refer to, in reference to a computer process, a timeframe that is faster than can be performed by human capabilities, or may refer to a length of time that is shorter than the time required for a human to typically respond (e.g., verbally) to audio signals.

The present disclosure describes computer systems and methods for providing real-time AI guidance that may include subject-specific information or other response for navigating a conversation. Specifically, the computer system may provide a guided participant with timely and accurate information during a conversation by functioning as an intelligent co-pilot.

In some embodiments, the computer system may comprise a unique hybrid, local-first architecture. The architecture may comprise a user interface (UI) shell for interacting with the local operating system to capture audio and/or display information. The UI shell may communicate with a persistent backend process that may run continuously on a computing device. The persistent, local backend may house the core AI models and logic, such that the computer system may be ready always for immediate, low-latency processing without the delays associated with loading models into memory upon each request. This design ensures data privacy, with flexibility to run in a virtual private cloud (VPC). The development of AI optimized chips (e.g., the M-series Apple chips) may enable the feasible design of local inference.

In some embodiments, the computer system may implement a real-time data processing pipeline. This pipeline is configured to ingest audio input from a conversation, send it to a transcription service, and receive a real-time text transcript (e.g., via Deepgram® speech to text service). A first subset of the text transcript may then be analyzed by a natural language processing (NLP) module (e.g., a local NLP module located on the computing device) to detect specific intents of the conversation participants, such as questions, requests, objections, or pain points. Upon detection of an intent (e.g., a business related question), the computer system may execute several filters and pipelines, including normalizing the intent and comparing the first subset of the text transcript (e.g., key words or phrases within to the text transcript) to a list of cached text (e.g., cached questions) within a local semantic cache (stored locally on the computing device). Each unit of cached text may be assigned a similarity score based on the degree to which the cached text is semantically-similar to the text transcript (or key words or phrases within the text transcript). The unit of cached text within the local semantic cache that has the highest similarity score, or those units of cached text having a similarity score exceeding a configurable similarity threshold, may be selected and a cached response associated with the cached text may be presented to the display. Querying the local semantic cache may enable deterministic and near instant responses, without the delay and power of direct LLM communication. In some embodiments, the computer system may additionally, or alternatively, comprise a semantic cache located on a cloud device accessible over a network connection.

If semantically-similar text (e.g., a semantically-similar question) is not found within the local semantic cache, a second subset of the text transcript (or associated key words or phrases within the text transcript) may be used to query a vector database for a retrieval-augmented generation (RAG) process. The vector database may be built from a private and/or subject-specific (e.g., a company-specific) knowledge base. The knowledge base may comprise a relatively large (e.g., when compared to the local semantic cache) amount of subject-specific information. For example, the knowledge base may comprise hundreds, or thousands, of documents pertinent to the subject of the conversation. The knowledge base may be integrated with e-mail and/or customer relationship management (CRM) systems to provide the most relevant content of the subject-specific information. The vector database may comprise high-dimensional vector data of information within the knowledge base to enable low-latency queries. This retrieved information may then be used as context for a large language model (LLM) to generate a concise, accurate, and factually grounded response.

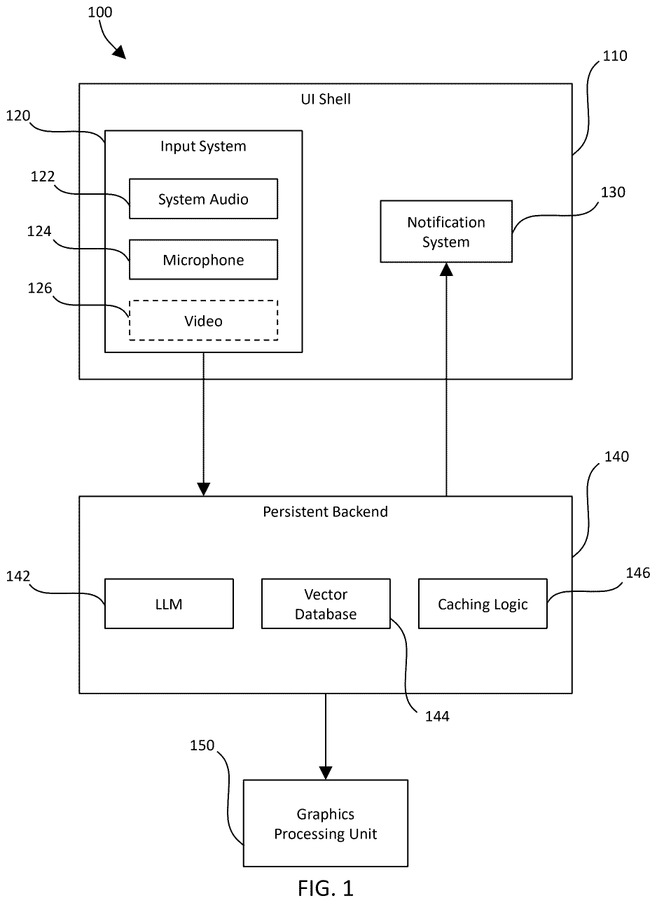

FIG. 1 illustrates a block diagram of a computer system 100 comprising additional system architecture that may be used to implement the computer system 100 and methods described herein. The computer system 100 may be implemented as a hybrid desktop application installed on a user's computing device (e.g., a laptop or desktop computer). The architecture can be designed as a local-first system to apply edge computing principles to conversational AI, thereby reducing latency and increasing data privacy of potential sensitive information in real-time conversations.

The system 100 may comprise two main components: a user interface (UI) shell 110 and a persistent backend 140. The UI shell 110, which may be implemented using a software framework (e.g., Electron®), for example, may serve as the user-facing portion of the computer system 100. The UI shell 110 may be responsible for managing native operating system interactions, such as an input system 120 for capturing audio from a microphone or system output, and rendering a notification system 130 on a display.

The UI Shell 110 may communicate with the persistent backend 140, which may run continuously as a background process on the computing device, for example, as a local asynchronous server gateway interface (e.g., Uvicorn). This persistent nature may enable the computer system 100 to eliminate model-loading delays during the conversation, ensuring the computer system's 100 AI capabilities may be generally or always available at sub-second response times. This local architecture may provide direct access to local hardware, such as a graphics processing unit (GPU) 528 (see FIG. 5) for model acceleration, and enables the computer system 100 to ensure that sensitive conversational data remains on the computing device, maximizing privacy and security.

The persistent backend 140 may house core AI components. These AI components may include a large language model (LLM) 142, a vector database 144, and caching logic 146. The LLM 142 may comprise a local LLM, such that the local LLM is located on the computer-readable media or other hardware of a local device, and may comprise any suitable compact, high-performance LLM model, such as those from the Llama or Mistral families. Additionally, or alternatively, the LLM 142 may comprise a cloud-based LLM that may be accessed over a network connection. The computer system 100 may use an LLM 142 selected according to the conversation participants. For example, the LLM 142 may be selected and tuned based on the conversation data from a prior conversation with the conversation participant. The LLM 142 may be trained to provide suggested responses that include attributes associated with better outcomes, according to previous conversation data, such as suggested responses that include attributes of agreeableness, persistence, or other attribute.

The vector database 144 may be implemented with one of several libraries, such as the Chroma DB or Lance DB libraries. The persistent backend 140 may be responsible for executing the entire real-time pipeline and the asynchronous agent tasks, described more fully below.

Before real-time operation, the system 100 may be populated with a knowledge base. The knowledge base may include a corpus of documents containing information that is subject-specific and pertinent to the subject and/or intents within the text transcript of the conversation. The knowledge base may additionally comprise information from past calls, including text transcripts of audio input of past calls (e.g., with one or more of the conversation participants, such as information comprising text transcripts from a call between the guided participant and another conversation participant). The knowledge base may comprise, for example, frequently asked questions, common responses, customer or participant-specific repositories, previous conversation data, and/or commitments.

The knowledge base may be stored in a location accessible to the computer system 100. For example, the knowledge base may be stored locally (e.g., at the storage device(s) 525) to decrease latency in accessing the documents of the knowledge base. Alternatively, the knowledge base may be stored in a location that may be accessible to multiple computing devices. For example, the knowledge base may be stored in a cloud device accessible over a network such that changes to the knowledge base may be reflected in responses generated across multiple computing devices. The knowledge documents may be stored in one or more of several formats, including markdown (.md) files, text (.txt) files, DOC (.doc, docx), PDF (.pdf) files, or other file formats. The vector database 144 may comprise a local vector database stored on a local device (e.g., the computing device of the guided participant) or may alternatively be stored on a cloud device (e.g., a central cloud server). For example, the knowledge base and the vector database 144 may be stored on a cloud device to facilitate data management. However, the computationally intensive RAG pipeline, including the LLM inference, may run locally on a local device, such as the user's computing device, to maintain low latency and privacy during the call.

The computer system 100 may be configured to integrate with external data sources via application programming interfaces (APIs). For example, the computer system 100 may connect to a CRM system to ingest past interaction notes associated with a conversation participant or may connect to a knowledge management platform to access the subject specific information (e.g., product documentation and/or company policies). Similarly, documents and information collected via the APIs can be included within the knowledge base.

Upon initiation, a vectorization script may be executed to read the content from all sources within the knowledge base and split the text of the sources into smaller, semantically-coherent segments. The vectorization script may then use a sentence-embedding model, such as one from a sentence-transformers library, to convert each text segment into a high-dimensional numerical vector embedding. These vector embeddings, which may capture the semantic meaning of the text, can be stored and indexed in the vector database 144, such as a Facebook AI similarity search (FAISS) index file stored on a local disk of the computing device. This may enable a highly efficient, searchable representation of the entire knowledge base that is optimized for fast semantic retrieval.

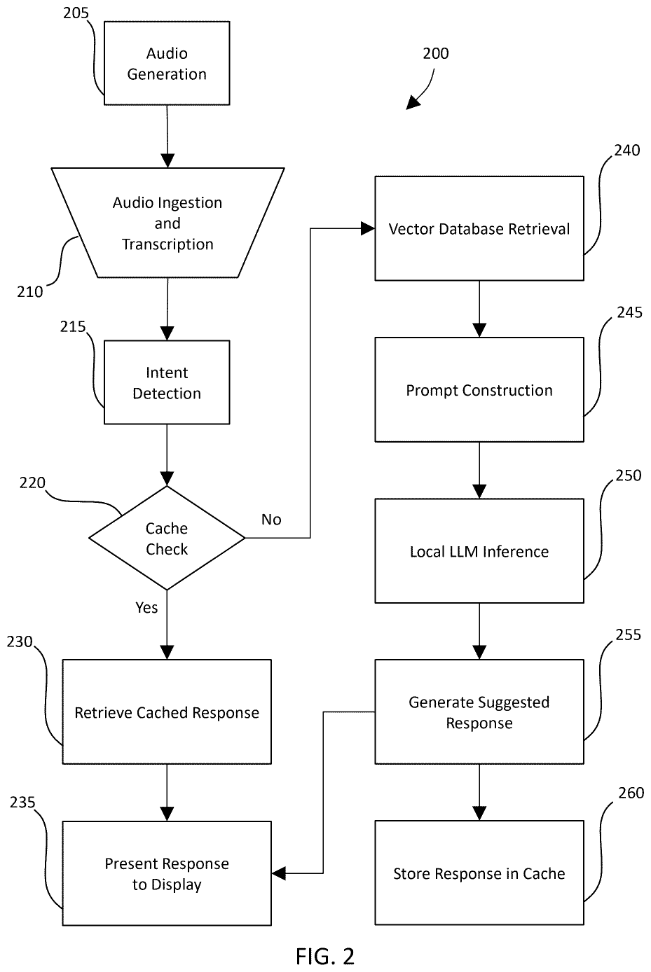

FIG. 2 illustrates a process 200 for providing real-time guidance comprising an AI generated response based on audio input. The process 200 represents the primary workflow of the application during a conversation (e.g., live call), the process 200 comprising a real-time analysis pipeline, or “hot path,” designed for minimal latency. The process may begin at step 205 wherein audio input is generated (e.g., when a conversation participant speaks). The conversation may be between a conversation participant and a guided participant. The conversation, for example, may occur via an online video or audio communication platform such as, for example, Teams, Zoom, Google Meet, Slack, Webex Meetings, HubSpot, an internet phone dialer, etc. The conversation participant, for example, may be remote relative to the guided participant and/or the computer system 100.

Thereafter, at step 210, the process 200 may include audio ingestion and transcription. For example, the UI shell 110 may receive audio input by capturing the system audio 122 (operating system level), including the audio input of the conversation. Additionally, or alternatively, the UI shell 110 may receive audio input through a network application or through an audio or video communication platform). Additionally, the UI shell 110 may access the microphone 124 of the computing device to receive audio input (e.g., from the guided participant at the computing device). In this manner, capture of the audio input is abstracted away from any specific communications application or other software, but is received from the system audio 122 and/or microphone 124 of the computing device. This audio input, for example, may be sent in real-time to a low-latency transcription service (e.g., Deepgram®), which may return a continuous stream of text transcript that textually represents the audio input of the conversation. The video 126 associated with the audio input of the conversation may also be received.

At step 215, the incoming text transcript may be (e.g., immediately) analyzed by a natural language processing (NLP) library (e.g., spaCy®) to detect an intent of the conversation. NLP libraries may comprise tools that enable computer systems to interpret, manipulate, and comprehend human language. The NLP library may identify the detected intent as a question, an objection, a pain point, or a request (e.g., direct request for information). The NLP library may comprise a deterministic component of the computer system 100, in that the NLP may be relied upon to classify text transcript input in a consistent manner. For example, if two distinct text transcripts contain identical characters in an identical order, the NLP may be relied upon to provide identical classifications for each of the two text transcripts.

Detection of the intent may trigger subsequent retrieval and generation process steps of the RAG pipeline (e.g., steps 230, 240, 245 described below). Subsequent retrieval and generation process steps may be triggered by alternative or additional mechanisms. The alternative or additional mechanisms may not depend on NLP-based intent detection. For example, the alternative or additional mechanisms for initiating subsequent retrieval and generation process steps may be triggered by detecting a specific keyword or phrase based on the audio input (e.g., identified within the text transcript) and/or by an emotional cue detected within a vocal tonality of the audio input.

Upon the detection of an intent, the system 100 may continue to step 220, wherein the computing system 100 consults the caching logic 146. The caching logic 146 may comprise an optimization layer that stores a repository of information including a plurality of cached responses (e.g., previously generated suggested responses) associated with cached texts (e.g., specific questions) within a local semantic cache. The local semantic cache may comprise a repository of information likely to be relevant to the subject of the audio input (e.g., information likely to be relevant to the discussion of a conversation). The information within the local semantic cache may be organized based on units of cached texts. The information may be relevant to the cached text, such that the information may be retrieved from the local semantic cache based on identification of the cached text.

The intent may be identified during the conversation, at which point the local semantic cache may be queried to retrieve low-latency information. For example, the information within the semantic cache may be information likely to be needed to answer a frequently asked question. The frequently asked question may be generated and stored within the local semantic cache based on questions identified within other conversations (e.g., previous conversations or conversations with other conversation participants). The local semantic cache may store cached texts, such as previously-processed text transcripts (or portions thereof, or texts (e.g., questions) based on previously-processed text transcripts), text derived from frequently asked questions, and/or text associated with critical information. The local semantic cache may be generated by the guided participant or an entity associated with the guided participant (e.g., a company employing a guided sales representative).

The local semantic cache may be generated by scraping a website for information. For example, the local semantic cache may be generated with frequently asked questions found on a website associated with the guided participant. In some embodiments, text may be stored in the local semantic cache when similar text (e.g., question) is detected from audio input from previous conversation participants above a set number of incidents (e.g., once the text (or relevant key words or phrases) has been detected 3, 5, 10, 15, or 20 times, or more). In such instances, a cached response associated with the cached text may be determined based on a median or average answer provided by previous participants (e.g., such that the local semantic cache is generated based on, at least in part, previous conversation recordings). In some embodiments, the cached text is labeled based on the intent. In some embodiments, the cached text and cached responses of the local semantic cache may be updated and/or compared to the knowledge base (e.g., at a predefined frequency or whenever the knowledge base is updated) to ensure accuracy.

To perform the similarity search, a first subset of the text transcript may be defined, with the first subset of the text transcript comprising the intent of the text transcript. The first subset of the text transcript may comprise key words or phrases of the text transcript to enable the local semantic cache to be searched based on the subject of the audio input. The system 100 may then convert the first subset of the text transcript (e.g., a new question) into a vector embedding and perform a similarity search against the cached texts (e.g., a previously-cached questions) within the caching logic 146. In some embodiments, the similarity search may rely on keyword matching (e.g., exact keyword matching). Alternatively, or additionally, the similarity search may rely on semantic similarity scoring (e.g., cosine similarity of embeddings) rather than exact keyword matching, providing the similarity search increased robustness to variations in phrasing of the text. In some embodiments, the similarity search may comprise a probabilistic model to determine the probability that the cached text is semantically similar, such as a bidirectional encoder representations from transformers (BERT) model, a ModernBERT model, an efficiently learning an encoder that classifies token replacements accurately (ELECTRA) model, a Longformer model, a FastText model, a hybrid model, or other probabilistic model.

A cached text may be considered semantically-similar to the first subset of the text transcript (e.g., a keyword or key phrase) if the cached text and the first subset text transcript “overlap” at or above a confidence threshold. For example, the cached text may be considered semantically-similar to the first subset of the text transcript if the cached text and the first subset of the text transcript overlap at an amount equal to or greater than a confidence threshold of 40%, 50%, 60%, 70%, 80%, 90%, 95%, or equal to or greater than a confidence threshold a range having any two of the foregoing as endpoints. The confidence threshold may be adjusted based on the subject-specific information and/or the conversation participant. For example, the confidence threshold may be lowered to enable more text transcripts to be found similar to cached texts, or the confidence threshold may be increased such that more new responses are generated by the LLM 142. In some embodiments, the cached texts may be classified in a manner similar to the detected intent (e.g., classified as a question, objection, pain point, or information request by the NLP) to decrease latency and speed similarity detection.

If a semantically-similar text (e.g., a cached question) is found within the local semantic cache and the semantically-similar text and the first subset of the text transcript are associated with a similarity score at or above a predefined threshold, the computer system 100 may retrieve a cached response (e.g., cached answer) associated with the semantically-similar text and serve the cached response (e.g., the cached answer) directly to the notification system 130 of the UI shell 110 at step 235, bypassing the rest of the pipeline. In this manner, responses to frequently asked questions (or other commonly-detected audio-based text transcript) may be provided near-instantaneously. However, if none of the cached texts (e.g., cached specific questions) are found semantically-similar to the first subset of the text transcript (e.g., do not have a similarity score at or above a confidence threshold), then the computer system 100 may not retrieve a cached response or present the cached response to the UI shell 110.

If no suitable answer is found within the caching logic 146 (that is, if no semantically-similar text is found), the computer system 100 may initiate the RAG pipeline with step 240 wherein relevant database content is retrieved from the vector database 144. To retrieve the relevant database content, the computer system 100 may define a second subset of the text transcript and vectorize the second subset (e.g., a question or objection) of the text transcript to a query vector to facilitate comparison between the second subset of the text transcript and information within the vector database. In some embodiments, the second subset of the text transcript may be a larger subset than the first subset of the text transcript, such that the first subset of the text transcript is a smaller portion of the text transcript than the second subset. This may be that a larger portion of the text transcript may be useful during querying of the vector database and prompting the LLM (see below) for providing additional context during search and prompt generation processes.

The query vector may be used to perform a similarity search against the content of the vector database 144. The similarity search may employ an approximate nearest neighbor (ANN) algorithm to rapidly retrieve relevant database content from the vector database 144. In some embodiments, the relevant database content may comprise the most relevant text segments from the knowledge base or may comprise subject-specific information within the vector database 144 that is closely connected with the subject of the audio input. For example, the similarity search may provide the most relevant text segment from the knowledge base, or may provide the most 2, 3, 4, 5, 6, 7, 8, 9, 10, or more than 10 relevant text segments from the knowledge base, or may provide the most relevant text segments within a range having any two foregoing values as endpoints.

The computer system 100 may then programmatically construct a new prompt for the LLM 142 at step 245. The prompt may be structured to include the relevant database content as the factual context, the detected intent, and/or the second subset of the text transcript (or portions thereof) to construct a context-augmented prompt. This prompt engineering ensures that the LLM 142 (e.g., a local LLM) is instructed to generate an answer based only on the approved information provided, which may significantly minimize the risk of factual inaccuracies or hallucinations. The prompt may further include text transcript (or portions thereof) of recent audio input, such as text transcript of the previous approximately 15, 30, 45, 60, 90, or 120 seconds of audio input, to provide additional conversation context for the second subset of the text transcript.

The prompt may additionally include external CRM conversation data. The external CRM conversation data may be conversation data relating to the conversation participant or an entity associated with the conversation participant (e.g., a business employing the conversation participant). The external CRM conversation data may enable the generated prompt to be tailored to the specific behavior of the conversation participant and to account for previous conversations with the conversation participant. For example, the provision of external CRM conversation data may be used to generate a response that is likely to be received well by the conversation participant or that is likely to induce the conversation participant to provide desired information and/or desired action.

In some embodiments, the prompt may be further augmented with data from real-time emotion detection, derived from vocal tonality analysis of the audio input and/or video analysis of facial expressions of conversation participants (e.g., from a video stream associated with the audio input), to tailor the tone or content of the suggested response. Similarly, an analysis of the emotional state may be provided with the prompt to the LLM, such that the response is based on the emotional state of the conversation participant. In this manner, generation of the prompt may be further based on the detected emotional state of a conversation participant.

In some embodiments, the suggested response may be based on a predefined conversational framework, such as an established sales framework (see below). For example, the suggested response may comprise a coaching prompt that includes a question or action item for the guided participant to voice to other conversation participants. The coaching prompt may conform to the established sales framework. For example, the coaching prompt may instruct the guided participant to identify with other conversation participant(s) if a product solves a particular need, according to the BANT sales framework.

The prompt may then be fed to the LLM 142 at step 250 for LLM inference. The LLM 142 may be a quantized model (e.g., using 4-bit or 8-bit precision) to achieve high performance on standard user hardware. The execution of the LLM 142 may be further accelerated by the local GPU 150. The LLM 142 may then process the prompt and generate a context-aware suggested response at step 255. The LLM 142 may be instructed such that the LLM 142 generates a concise answer. For example, the LLM 142 may generate an answer that is 1, 2, 3, 4, 5, or more than 5 sentences. In another example, the LLM 142 may generate an answer within a maximum number of characters, such as a maximum of 50, 100, 150, 200, 250, or 300 characters.

The generated response may then be sent back to the UI Shell 110 and displayed to the user via the notification system 130 at step 235. The generated response may be displayed in real time, such as simultaneously with and/or before receiving additional audio input. Concurrently, the second subset of the text transcript (or text derived therefrom) and the newly generated response may be stored in the local semantic cache at step 260 to accelerate providing future responses.

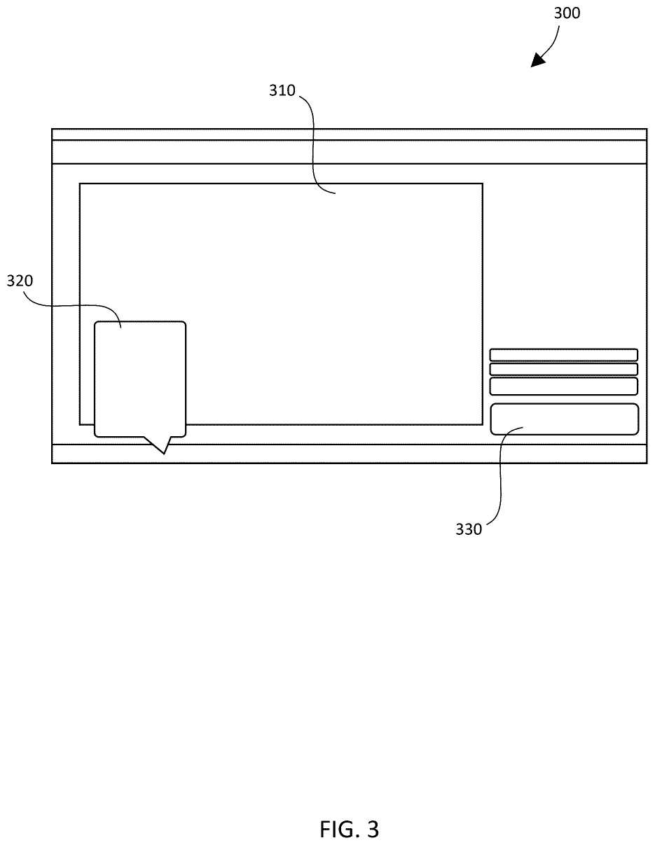

FIG. 3 illustrates a user interface (UI) 300 that may be used by the computer system 100 to provide the generated suggested response (or other information) to the guided participant. The UI 300 may include, for example, a graphical user interface of an application of a video or audio communication platform. The UI 300 may include a video panel 310 for sharing video of a conversation participant.

The suggested response may be presented by the computer system 100 to the UI 300 in a graphical overlay. The graphical overlay may comprise a panel or other textual interface. The suggested response may be presented via a third-party application (i.e., an application distinct from a video or audio communication platform), such that the process 200 is implemented via the third-party application executing in parallel to the, for example, video or audio communication platform, or may be presented by the a video or audio communication platform, such that the notification system is embedded within the graphical user interface of the video or audio communication platform. For example, the suggested response generated by the computer system 100 may be presented to the UI 300 via a graphical overlay comprising a popup panel 320 (e.g., of a third-party application) or may be presented to the UI 300 via a graphical overlay comprising a response panel 330 embedded within the graphical user interface of the communication platform.

In some embodiments, suggested responses may be presented to the display, for example, in a corner of a guided participant's screen, or may be configured to appear in a location chosen by the guided participant. The notification comprising the suggested response may be color-coded based on the type of notification, and/or may include other visual identifiers, such as icons or pulsing color visuals.

In some embodiments, suggested responses (or keywords or other information) may be presented to the guided participant via audio. The audio presented to the guided participant may not be shared with other conversation participants.

In some embodiments, an alert may accompany the generated response. The alert may comprise information that identifies the source of the information. For example, the alert may identify the segment of the knowledge base from which the information was generated. The alert may report whether the suggested response comprised a cached response associated with a semantically-similar text or was newly generated by the LLM.

In some embodiments, the computer system 100 may generate a suggested response based on changes to the knowledge base. For example, the computer system 100 may not provide a cached response if the cached response was generated before subsequent alterations to the knowledge base, or specifically to the segment of the knowledge base on which the cached response relies.

In some embodiments, the computer system 100 may receive input to generate a new response. For example, the guided participant may trigger the generation of a new response based on an input from the guided participant to the computing device. In some embodiments, the guided participant may trigger the generation of a new response after a cached response has been presented, such that a new response is presented in addition to the cached response based on a local input to the computer system 100. This may enable the guided participant to rely on the totality of the conversation input (e.g., audio input including vocal tonality and emotional state, as well as the video input) to generate a new response, rather than relying on a cached response.

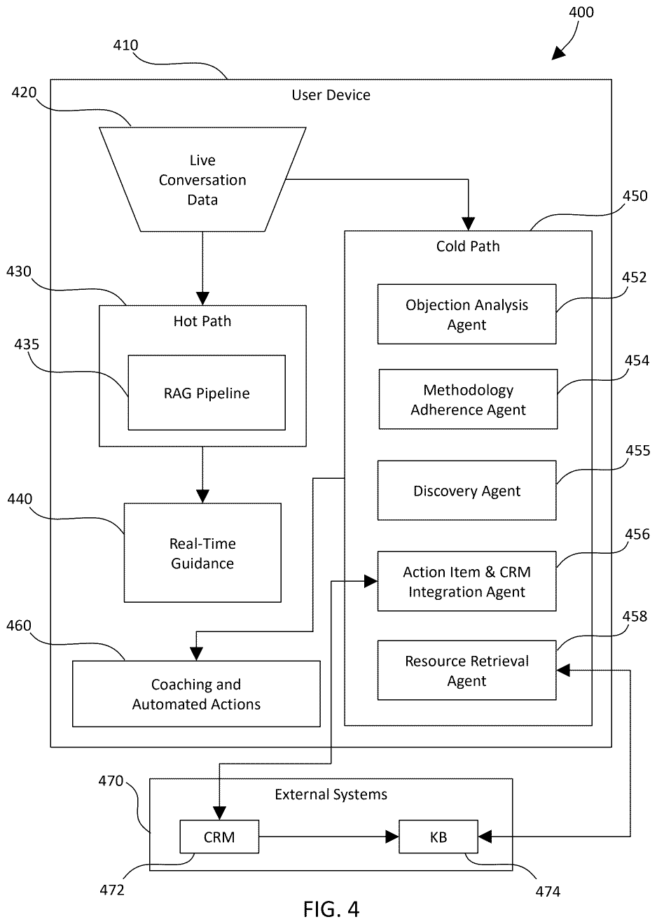

FIG. 4 illustrates a diagram 400 of the user device 410 and external systems 470, and illustrates that the user device 410 may comprise a bifurcated architecture that implements a time-critical hot path 430, including the RAG pipeline 435 to provide real-time guidance 440, and a separate, parallel, asynchronous cold path 450. The cold path 450 may be asynchronous, in that the cold path 450 may be implemented after the conversation has terminated to analyze the response of the guided participant and the audio input of all the conversation participants. The cold path 450 may additionally, or alternatively, operate in parallel to the hot path 430 to provide more intensive analysis. In some embodiments, the cold path 450 may require larger computer resources, such that suggested responses from the cold path 450 are delivered to the guided participant at greater latency (e.g., up to 15 seconds after detection of an intent), while in other embodiments, the cold path 450 may operate to provide suggested responses at or near the same speed as the hot path 430.

Both the hot path 430 and the cold path 450 may depend on analysis of the same live conversation data 420 (e.g., audio and video input from the conversation). This dual-path design may enable the system to provide both immediate intent detection and responses, and deeper strategic assistance without one path compromising the performance of the other. While the hot path 430 may focus on low-latency RAG, the cold path may utilize specialized AI agents that perform more computationally intensive analysis in the background, either during or after the conversation. These agents may operate on the conversational data (e.g., the text transcript) and may interact with external systems 470, such as a CRM Database 472 and an external knowledge base (KB) 474.

The cold path 450 may include agents such as an objection analysis agent 452, a methodology adherence agent 454, a discovery agent 455, an action item & CRM integration agent 456, and/or a resource retrieval agent 458 for providing coaching and automated actions 460 that are provided to the guided participant, for example, after the termination of the conversation. The objection analysis agent 452 may asynchronously process transcripts from current and/or past conversations to identify recurring objections using clustering algorithms. The objection analysis agent 452 can then provide the user with coaching prompts, proactive strategies, and/or updated documentation to better handle these common points of friction. The methodology adherence agent 454 may assess the conversational flow against predefined conversational framework, such as established sales frameworks (e.g., MEDDICC, MEDPICC, and/or BANT methodologies). The methodology adherence agent 454 can provide real-time prompts to the user if it detects that the guided participant has deviated from the predefined conversational framework or missed a key stage, such as qualification or identifying pain points.

The discovery agent 455 can maintain a dynamic checklist of critical information that needs to be gathered during the conversation. The discovery agent 455 may track the conversation and prompt the guided participant to ask questions to fill in any missing details, ensuring thorough discovery.

The action item and CRM integration agent 456 may use named entity recognition (NER) and event extraction models to automatically detect commitments and action items within the conversation (e.g., within the text transcript). The agent 456 can then leverage dedicated SDKs or representational state transfer (REST) APIs to create tasks, update contact records, or log notes in the integrated CRM database 472, automating administrative work, and/or ensuring follow-through. In some embodiments, the agent 456 may identify an action item within the text transcript based on an NER model and transmit data corresponding to the action item to an external CRM system.

After the termination of the call, the resource retrieval agent 458 may analyze the main topics of discussion and may automatically search the knowledge base 474 for relevant case studies, white papers, or technical documentation. The resource retrieval agent 458 can then present these resources to the user. In some embodiments, the computer system 100 may generate automated email drafts or other communications after the termination of the conversation, wherein the email drafts or other communications contain subject-specific information or other resources pertinent to the conversation as follow-up.

The computer system 100 may deliver information to the guided participant in a manner that enhances, rather than disrupts, human-to-human interaction. The application may run quietly in the background, requiring little or no manual interaction so as not to disrupt the generation of audio input (e.g., of a conversation). When suggested response is generated, it may appear automatically in a discreet, non-intrusive notification. For example, a discreet, non-intrusive notifications may comprise a message generated on a dialog window, a pop-up, or other visual indicator. In some embodiments, the notification may comprise an audio notification (e.g., an AI text-to-speech instruction).

The notification of the response or coaching prompt may be invisible to conversation participants other than the guided participant while using screen sharing services. For example, the user of the computing device (i.e., the guided participant), during the conversation wherein audio and/or video is shared (e.g., through a network connection) with other computing devices, may share the video of the display of the computing device (e.g., to provide or otherwise illustrate subject-specific information). However, in such instances, the suggested responses generated by the computer system 100 may not be shared with the other computing devices of the other conversational participants.

Sharing of content present on the display of the UI shell, while not sharing notifications from the RAG pipeline, may be achieved through a technical method of operating system-level overlay rendering. The computer system 100 may utilize specific operating system APIs to create a window or graphical layer that is explicitly marked to be excluded from the capture streams of common screen-sharing and recording applications. This enables the computer system 100 to provide the guided participant with private, real-time coaching and answers without notifying other participants in a video call and preserving the natural flow of the conversation.

The computational system 500, shown in FIG. 5, can be used to perform any of the embodiments of the invention. For example, computational system 500 can be used to execute process 200 described above. As another example, computational system 500 can be used to perform any calculation, identification, and/or determination described here. Computational system 500 includes hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard, and/or the like; and one or more output devices 520, which can include without limitation a display device, a printer, and/or the like.

The computational system 500 may further include (and/or be in communication with) one or more storage devices 525 (e.g., one or more computer-readable media or non-transitory computer-readable medium), which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The one or more storage device 525, may comprise instructions that cause the one or more processor(s) 510 to implement the methods described herein. In some embodiments, the instructions stored on the one or more computer-readable media may be executed on a single electronic device, specifically, the guided participant's computing device. The guided participant's device may comprise a portable device (e.g., a laptop or smartphone). The computational system 500 might also include a communications subsystem 530, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 530 may permit data to be exchanged with a network (such as the network described below, to name one example), and/or any other devices described herein. In many embodiments, the computational system 500 will further include a working memory 535, which can include a RAM or ROM device, as described above.

The computational system 500 also can include software elements, shown as being currently located within the working memory 535, including an operating system 540 and/or other code, such as one or more application programs 545, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 525 described above.

In some cases, the storage medium might be incorporated within the computational system 500 or in communication with the computational system 500. In other embodiments, the storage medium might be separate from a computational system 500 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 500 and/or might take the form of source and/or installable code, which, upon compilation and/or installation on the computational system 500 (e.g., using any of a variety of generally available compilers, installation programs, compression/decompression utilities, etc.) then takes the form of executable code.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A computer system for generating instructions in real time based on audio input, the computer system comprising:
a display comprising a user interface for presenting instructions;
a network connection;
one or more processors communicatively coupled with the display and the network connection; and
one or more computer-readable media having stored thereon instructions that when executed cause the one or more processors to:
receive the audio input transmitted over the network connection;
transcribe the audio input into a text transcript;
determine via a natural language processing model whether a first subset of the text transcript includes intent comprising one of an objection, question, request, or pain point; and
when an intent is detected within the text transcript:
query a semantic cache for a semantically-similar text as the first subset of the text transcript, wherein the semantic cache comprises a repository of information including a plurality of cached responses to specific questions;
when the semantically-similar text is found, present a cached response associated with the semantically-similar text via the display in real time; and
when the semantically-similar text is not found:
query a knowledge base based on a second subset of the text transcript to retrieve relevant database content, wherein the relevant database content comprises subject-specific information within the knowledge base;
generate a prompt including the second subset of the text transcript, the intent, and the relevant database content;
provide the prompt to a large language model (LLM) to generate a new response based on the text transcript, the intent, and the relevant database content; and
present the new response via the display in real time.

2. The computer system of claim 1, wherein the query for a semantically-similar text as the first subset of the text transcript is performed by a probabilistic model, wherein each of the specific questions of the semantic cache are assigned a similarity score, and wherein the cached response is presented only when at least one of the specific questions of the semantic cache has a similarity score above a confidence threshold.

3. The computer system of claim 1, wherein instructions further cause the one or more processors to present the cached response or new response in a graphical overlay of the display that is excluded from video capture streams of screen-sharing applications.

4. The computer system of claim 1, wherein when semantically-similar text is not found within the semantic cache and after the new response is generated, the instructions further cause the one or more processors to store the second subset of the text transcript within the semantic cache and associate the new response with the second subset of the text transcript.

5. The computer system of claim 1, wherein the first subset is a smaller portion of the text transcript than the second subset.

6. The computer system of claim 1, wherein the instructions further cause the one or more processors to analyze a vocal tonality of the audio input.

7. The computer system of claim 1, wherein the instructions further cause the one or more processors to analyze a video stream associated with the audio input to detect an emotional state, and wherein generation of the prompt provided to the LLM is further based on the emotional state, such that the new response is based on the emotional state.

8. The computer system of claim 1, wherein the instructions further cause the one or more processors to asynchronously analyze the text transcript against a predefined conversational framework by a methodology adherence agent, wherein the cached response or the new response is accompanied by a coaching prompt generated by the LLM conforming to the predefined conversational framework, and wherein the coaching prompt is generated when a deviation from the predefined conversational framework is detected.

9. The computer system of claim 1, wherein the instructions further cause the one or more processors to identify an action item within the text transcript based on a named entity recognition (NER) model and transmit data corresponding to the action item to an external customer relationship management (CRM) system.

10. The computer system of claim 1, wherein the knowledge base is stored on a cloud device and the LLM comprises a local LLM and is stored on a local device.

11. The computer system of claim 1, wherein the LLM comprises a cloud-based LLM accessible over the network connection.

12. The computer system of claim 1, wherein the semantic cache comprises a local semantic cache stored on the one or more computer-readable media.

13. The computer system of claim 1, wherein when semantically-similar text is found, the computer system outputs to the display an indication that the cached response is associated with the semantically-similar text.

14. The computer system of claim 13, wherein the instructions further cause the one or more processors to present a new response in addition to the cached response based on a local input to the computer system.

15. The computer system of claim 1, wherein querying the semantic cache includes employing a probabilistic model to assign a similarity score to each of the specific questions within the semantic cache based on a similarity of each of the specific questions to the first subset of the text transcript, and wherein the semantically-similar text is chosen from among the specific questions that has a highest similarity score and which exceeds a confidence threshold.

16. A method for generating instructions in real time based on audio input, the method comprising:
receiving the audio input transmitted over a network connection;
transcribing the audio input into a text transcript;
determining via a natural language processing model whether a first subset of the text transcript includes an intent comprising one of an objection, question, request, or pain point; and
when an intent is detected within the text transcript:
querying a semantic cache for a semantically-similar text as the first subset of the text transcript, wherein the semantic cache comprises a repository of information including a plurality of cached responses to specific questions;
when the semantically-similar text is found, presenting a cached response associated with the semantically-similar text via a display in real time; and
when the semantically-similar text is not found:
querying a knowledge base based on a second subset of the text transcript to retrieve relevant database content, wherein the relevant database content comprises subject-specific information within the knowledge base;
generating a prompt including the second subset of the text transcript, the intent, and the relevant database content;
providing the prompt to a cloud-based large language model (LLM) to generate a new response based on the text transcript, the intent, and the relevant database content; and
presenting the new response via the display in real time.

17. The method of claim 16, wherein the method further comprises presenting the cached response or the new response in a graphical overlay of the display that is excluded from video capture streams of screen-sharing applications.

18. The method of claim 16, wherein the method further comprises asynchronously analyzing the text transcript against a predefined conversational framework by a methodology adherence agent, wherein the cached response or the new response is accompanied by a coaching prompt generated by the LLM conforming to the predefined conversational framework, and wherein the coaching prompt is generated when a deviation from the predefined conversational framework is detected.

19. The method of claim 16, wherein the method further comprises identifying an action item within the text transcript based on a named entity recognition (NER) model and transmit data corresponding to the action item to an external customer relationship management (CRM) system.

20. A non-transitory computer-readable medium storing a communication assistance program including instructions that, when executed by a processor, causes the processor connected to a display through a communication interface to:
receive audio input;
transcribe the audio input into a text transcript;
determine via a natural language processing model whether a first subset of the text transcript includes intent comprising one of an objection, question, request, or pain point; and
when an intent is detected within the text transcript:
query a semantic cache for a semantically-similar text as the first subset of the text transcript, wherein the semantic cache comprises a repository of information including a plurality of cached responses to specific questions;
when the semantically-similar text is found, present a cached response associated with the semantically-similar text via the display in real time; and
when the semantically-similar text is not found:
query a knowledge based on a second subset of the text transcript to retrieve relevant database content, wherein the relevant database content comprises subject-specific information within the knowledge base;
generate a prompt including the second subset of the text transcript, the intent, and the relevant database content;
provide the prompt to a large language model (LLM) to generate a new response based on the text transcript, the intent, and the relevant database content; and
present the new response via the display in real time.
